(19) United States
(12) Patent Application Publication
(10) Pub. No.: US 2006/0226956 A1
(43) Pub. Date: Oct. 12, 2006

(54) LED assembly with a communication protocol for LED light engines

(75) Inventors: Garrett Young, Freehold, NJ (US); David Weimer, Tuckerton, NJ (US)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: DIALIGHT CORPORATION, FARMINGDALE, NJ (US)

(21) Appl. No.: 11/100,394

(22) Filed: Apr. 7, 2005

(51) Int. Cl. G09F 25/00

(52) U.S. Cl. 340/286.01

(57) ABSTRACT

A system including LED assemblies, which system can efficiently and consistently provide a desired color output. The system includes a network and a plurality of light emitting diode (LED) assemblies connected to the network. Each LED assembly includes a unique address. Further, a control unit is connected to the network and is configured to send light control signals to the LED assemblies individually. The light control signals include color information in a universal color coordinate system. The universal color coordinate system can be the CIE color coordinate system and the network can utilize an Ethernet communication protocol.

### BACKGROUND OF THE INVENTION

1. Field of the Invention

The present invention is directed to an LED (light emitting diode) assembly with a communication protocol for LED light engine, and to a method of manufacturing the LED assembly, and which is particularly adapted to address issues of color differences between different LEDs within the LED assembly.

2. Description of the Background Art

Traditional light sources are most commonly either incandescent or gas discharge. Each has advantages and disadvantages. Although inexpensive to manufacture, the traditional incandescent bulb suffers from two disadvantages. First, most of the input energy of traditional lighting is wasted as heat or infrared (non-visible) light; only a small amount of the input energy is transferred to visible light. Second, the lifetime of the incandescent bulb is limited and when failure occurs it is catastrophic. Traditional fluorescent bulbs have a longer life, but have significant performance variations across a range of temperatures. At some colder temperatures fluorescent bulbs do not function at all. Halogen light sources are a slight improvement in efficiency and lifetime over incandescent light sources for a marginal increase in cost.

Traditional sources of lighting can produce exact colors by filtering. The filtering process takes white lighting and removes all the light except the required light of the specified color and therefore further reduces the efficiency of the light source. Traditional lighting also is broadcast in all directions from the source, which may not be advantageous when the goal is to illuminate a small object. Lastly, traditional lighting has a non-linear relationship between brightness and input current. This non-linearity makes it difficult to dim the light source easily.

LEDs overcome many of the disadvantages of traditional lighting because of their significantly longer lifetime, higher efficiency, and ability to direct the light. The Mean Time Between Failures (MTBF) of typical incandescent light sources is in the order of 10,000 hours. The MTBF of LEDs is on the order of 1-10 million hours. Typically only 5% of the input energy is transferred to visible light for an incandescent light. Similarly, for LEDs about 15% of the input energy is transferred to visible light. The ratio of lumens of light output divided by the watts of input energy is another way to look at the efficiency. Traditional lighting has about 17 lumens/watt, whereas LED based (white) light sources are about 35 lumens/watt. The efficiency improvement equates to lower power consumption or higher light output for similar applied power. Generally, an individual LED produces a low level of light output that is insufficient for usage as a light source. Combining a number of LEDs into an assembly or array allows the array to be a reliable and cost effective replacement for traditional light sources.

When designed and fabricated, an array of LEDs in an assembly can be electrically interconnected in parallel, in-series, or any combination thereof. Additionally, the LEDs in the assembly can be a single base color or many different colors. By combining several different colors into one assembly, a wide range of specified colors can be displayed by the light engine. These LED light engine assemblies are gaining widespread usage because of their ability to reduce electrical usage, improve maintenance costs, and allow dynamic, custom color projection.

LED assemblies are also rapidly replacing light bulbs in the Human Safety marketplace. Human Safety applications might include traffic lights, safety beacons on towers, warning lights at rail crossings, emergency egress lighting, aircraft runway lighting, and many more applications. In these applications LED light sources are gaining popularity for two reasons: (1) the increased reliability of LEDs, and (2) the reduced costs and difficulty of the repair and maintenance functions.

At the present time LED based light engines are in operation for Human Safety Applications in hundreds of thousands locations throughout the world.

LED lighting is also beneficial in architectural and theatrical applications. The benefit lies not only with the ability to produce an exact and repeatable light for changing moods and emotions but also with the ability to produce these colors dynamically and across a large number of light sources. This practice has been available in theatrical lighting for many years in various forms with tremendous improvement in digital color on demand in the relatively recent past. For architecture, the practical use of color remains limited largely due to the cumbersome use of theatrical grade fixtures in architectural applications. The promise of LED lighting is the ability to accomplish dynamic color in a more useful form factor and in real time for both theater and architectural applications.

A typical LED assembly includes a number of LEDs installed into a system, and typically all of the LEDs are a single base color. The technology is progressing and new requirements are emerging for the production of a broad spectrum of colors from combinations of two, three, four or more base colors of LEDs. Many assemblies under development include several Red LEDs, several Green LEDs, and several Blue LEDs. Several LEDs are needed of each color, because a single LED does not provide sufficient light for a light engine. Different LED colors are needed so that the different colors can be combined to make a broad spectrum of custom lighting effects.

A generalized LED assembly 10 is shown in FIG. 1. The LED assembly 10 includes an LED light source 11, which in turn includes individual LEDs 12 of different colors represented by the designators—R (red), G (green), and B (blue). The LED assembly 11 includes the LEDs 12 and a support and associated circuitry for driving the LEDs. The associated circuit and support includes an electronic carrier or printed circuit board (not shown) to mechanically hold the LEDs 12 and to provide electrical input to the LEDs 12, a power supply 13 to convert input power into a usable form for the LEDs 12, control electronics 14 to turn the LEDs 12 on and off appropriately, perform algorithms on the electronic signal and communicate with other equipment in a larger lighting system, and a lens or diffuser (not shown) to modify the light appearance from several small point sources to a look that is both pleasing to a human and functional for the product.

LED assemblies do, however, have the following disadvantages recognized by the present inventor. Variations within manufacturing of the optical and electrical output properties are sizeable. Targeted output colors are difficult to achieve because of the manufacturing variations of the LEDs. The optical output varies over the product lifetime; for instance, the output intensity degrades with time. The dominant wavelength is highly dependent on temperature. And, intensity drops with temperature increases.

Further, for LEDs different semiconductor compounds are used to produce different colors. Each compound will change at a different rate with respect to temperature and long term degradation. This has made the color stability of an array of RGB (Red, Green, Blue) LEDs difficult.

The fact that LED light output varies proportionately with input current is generally an advantage of LEDs; it becomes a disadvantage when an LED assembly is used as a direct replacement for an incandescent bulb. This is because the control system compensates for the non-linearity of the incandescent bulb and produces nonsensical output with the replacement LED assembly.

Lighting control systems or consoles address a limited number of light outputs with a limited number of possible color specifications and may require cumbersome hardware to address large lighting systems.

Temperature variations of the LEDs can occur for two reasons. One source is the outside environment. LED light sources can be installed in controlled temperature environments, examples of which would be home or office buildings. Alternatively, they can be installed in uncontrolled temperature environments where temperature variations are in the range of human habitability and beyond. The second source of temperature variability is the efficacy of the thermal dissipation within the specific system. Optical output properties are related to the die temperature. The die temperature is related to the outside environment, but also the thermal resistance of the entire path from the die to the outside world.

The dominant wavelength (represented by 1d) and the optical intensity exhibit quantifiable changes with these temperature changes. With sufficient temperature variations the change in the dominant wavelength can be discernible by the human eye. At some wavelengths (near the color amber) changes of 2-3 nanometers (nm) are discernible to the human eye; at other wavelengths (near the color red) changes of 20-25 nm are required before the human eye can differentiate a color shift. The intensity change with temperature is discernible as well. Temperature increases of 60° C. can reduce output by approximately 50%.

The current state of the art partially addresses the issues. The manufacturing variation of the LED optical output is resolved by sorting or binning the LEDs into groupings of similar optical properties. The optical response of an incandescent light has been mimicked in the control software and hardware for the array, see for example U.S. Pat. No. 6,683,419. The initial power output of the LED can also be over-driven, which results in acceptable power outputs over a longer period of time.

The current state of the art, however, does not resolve the following issues. Exact color generation of a specified color is still not achievable. Binning of the LEDs is not always sufficient to produce an accurate color across all environments because of the wide variations in the LED optical properties within a bin. Temperature variation and time degradation effects on LED output wavelength and intensity are not compensated for.

### SUMMARY OF THE INVENTION

Accordingly, one object of the present invention is to provide a novel LED assembly and novel method of manufacturing the LED assembly that can efficiently and consistently provide a desired color output of the LED assembly.

The present invention achieves the above and other objects by providing a system including a network and a plurality of light emitting diode (LED) assemblies connected to the network. Each LED assembly includes a unique address. Further, a control unit is connected to the network and is configured to send light control signals to the LED assemblies individually. The light control signals include color information in a universal color coordinate system. The universal color coordinate system can be the CIE color coordinate system and the network can utilize an Ethernet communication protocol.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 shows a generalized background LED light assembly;

FIG. 2 explains LED color specifications on a CIE chromaticity chart;

FIGS. 3a and 3b show processes for uncompensated optical output of an LED assembly;

FIG. 4 shows a process flow of operations conducted in a method of manufacturing an LED assembly according to the present invention;

FIG. 5 shows a simplified pictorial of a manufacturing fixture utilized in a method of manufacturing the LED of the present invention;

FIGS. 6a, 6b show an overview of processes for realizing a compensated optical output for an LED assembly of the present invention;

FIG. 7 shows an LED light engine assembly of a first embodiment of the present invention;

FIG. 8 shows a more generalized operation of processes performed in manufacturing an LED assembly according to the present invention;

FIG. 9 shows RGB color specification on a CIE chromaticity chart;

FIG. 10 shows the effects on rendered color of RGB color specifications on a CIE chromaticity chart;

FIG. 11 shows a background DMX512 packet format;

FIG. 12 shows a light system as a further embodiment of the present invention;

FIG. 13 shows an LED light engine assembly in a further embodiment of the present invention;

FIG. 14 shows a standard Ethernet frame for communication;

FIG. 15 shows frame contents that can be utilized in the further embodiment of the present invention; and

FIG. 16 shows a modification of frame contents that can be utilized in the further embodiment of the present invention.

### DESCRIPTION OF THE PREFERRED EMBODIMENTS

Referring now to the drawings, wherein like reference numerals designate identical or corresponding parts throughout the several views, features of the present invention are detailed.

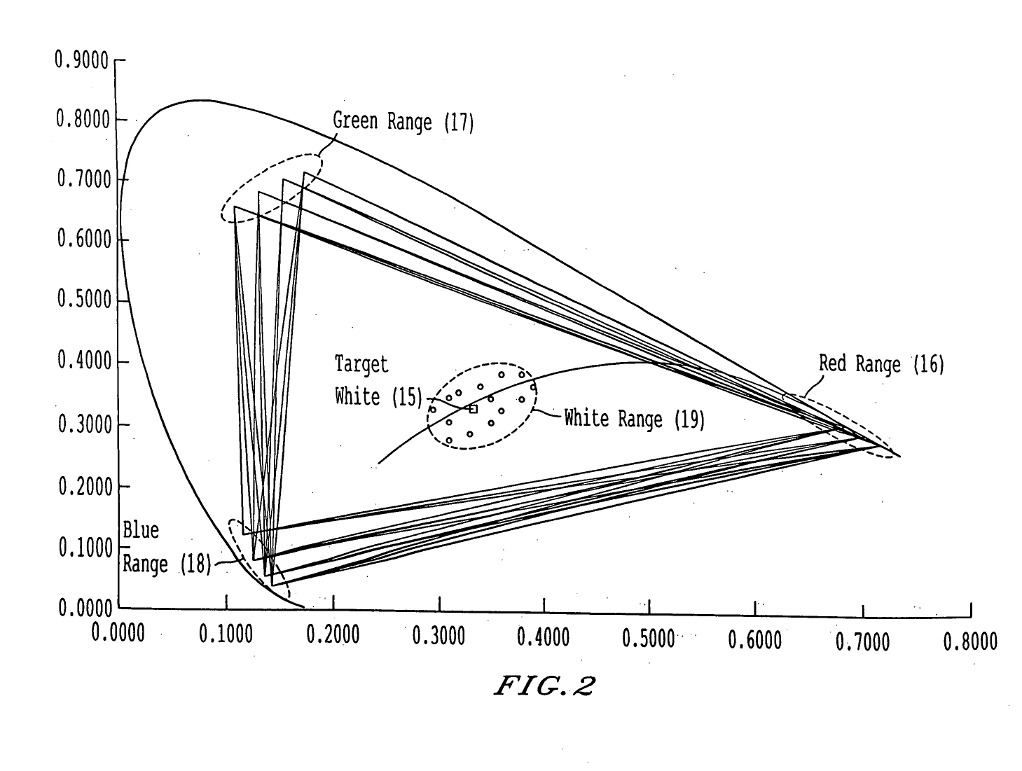

Color output can be specified using the CIE Color Coordinate System. Other appropriate schemes for specifying color can also be utilized. CIE is an abbreviation for “The Commission Internationale de l'Eclairage” and is an international standards development group that first described ways of quantifying color in a standard written in 1931. The CIE Color Coordinate System is an accepted standard for the measurement of a spectral distribution and defines a color using an x coordinate, a y coordinate, and a Y′ coordinate. The CIE Color Coordinate System is a device independent way of describing color and is therefore also described as a universal coordinate system for defining colors, and is shown graphically in FIG. 2. FIG. 2 shows the CIE Chromaticity Chart with the CIE Color torque. The CIE Color torque shows the x, y, and Y′ coordinates for saturated colors. The x coordinate and the y coordinates are normalized and are represented on a scale of 0 to 1. Both x and y coordinates are unitless and specify the color. Y′ specifies the intensity and is normalized to a unitless number as well.

Typical Red, Green, and Blue LED color outputs are shown in FIG. 2. By interconnecting coordinates representing Red, Green, and Blue, a triangle is created. The CIE coordinates within this triangle represent the range of available colors for display. Points outside of the triangle can not be displayed with the given light sources. The center point of the triangle is the CIE coordinate of the max combination of the Red, Green, and Blue light sources and is theoretically White.

The manufacturing process for the production of LEDs is inconsistent and produces LEDs with a large variability in their output. This variability is shown for Red, Green, and Blue graphically by the span of the ovals (16), (17), and (18) respectively. FIG. 2 also identifies a Target White (15) and shows an additional oval (19) that represents the range of displayed White for combinations of the three color light sources of Red (16), Green (17), and Blue (18).

FIG. 2 shows the white range (19) of the displayed color without compensation for the many sources of variability of the LEDs. This variability of the individual LEDs includes degradation in output intensity over the LED lifetime, changes in dominant wavelength with temperature, changes in output intensity with temperature, variability within the manufacturing process, and more.

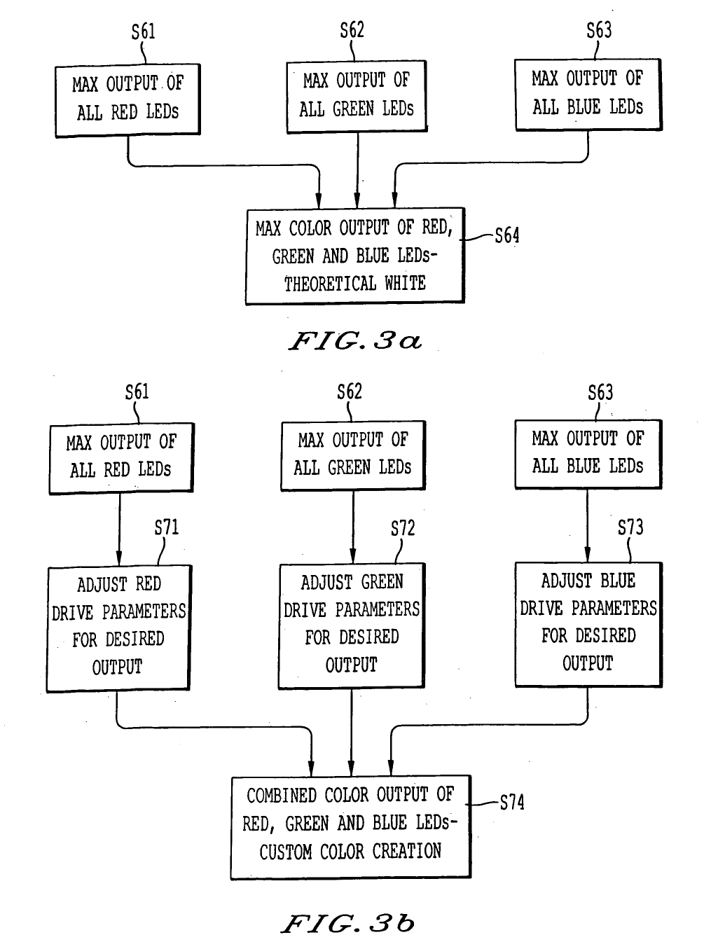

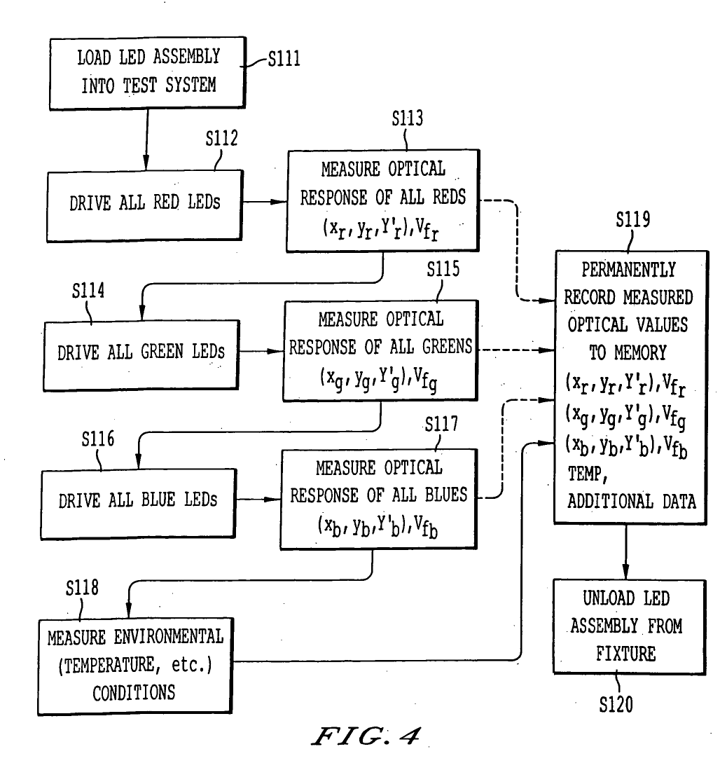

FIG. 3a is a simplistic or uncompensated process for producing white light from the output of Red, Green, and Blue LEDs. The process shown in FIG. 3 includes three simultaneous steps S61, S62, and S63 in which respectively a maximum output of all of the red LEDs, a maximum output of all the green LEDs, and a maximum output of all the blue LEDs are generated. By performing those steps driving each of the Red, Green, and Blue LEDs to their maximum output, a maximum color output of the Red, Green, and Blue LEDs is generated in step S64 giving a theoretical white light output. That is, maximally mixing the Red, Green, and Blue, LEDs should provide a white light. However, because of differences between color outputs of individual of the LEDs, such a system has a drawback in that the variations in the color outputs of the Red, Green, and Blue LEDs may not result in a pure white output. The variability of the output from the process of FIG. 3a is shown on the CIE Chromaticity Chart in FIG. 2 as (19) and may be sufficient to cause a measurable difference of the white light from a theoretical white. The difference may be discernible by the human eye. The additive process of FIG. 3a does not compensate for LED variability and may produce an inexact white. In addition to being inaccurate the result is inconsistent.

FIG. 3b is a similar simplistic or uncompensated process to produce a custom color. In the process of FIG. 3b, initially each of the Red, Green, and Blue LEDs are each driven at their maximum output in steps S61, S62, S63, as in FIG. 3a. Then, a scaling is introduced to each of those outputs to produce a desired color. More specifically, step S71 adjusts Red LEDs drive parameters to obtain a desired Red light output, step S72 adjusts Green LEDs drive parameters to obtain a desired Green light output, and step S73 adjusts Blue LEDs drive parameters to achieve a desired Blue light output. Each of steps S71, S72, and S73 can achieve the desired scaling by modifying drive parameters such as duty cycle and drive current for each of the respective Red, Green, and Blue LED outputs. The combined output is, ideally, the desired custom color. Unfortunately this simplistic process may also yield unacceptable results. LED variability at each of the three input stimuli induced by a number of factors may yield an inaccurate and inconsistent representation of the target color.

Single color LED light engine assemblies have been in production for a number of years. The variability associated with the fabrication of single color LEDs and the precise requirements of the Human Safety marketplace, where they have chiefly been implemented, have challenged the LED assembler to produce an accurate output color for the entire system. The LED manufacturers have assisted the assemblers by pre-sorting or binning the LEDs into smaller ranges of variability prior to shipment. The smaller range of LED input stimuli has assisted the assembler in producing a target output color. Acceptable color rendering is still a demanding task because even the bins have a sizeable range of the performance variations.

The binning operation can become complex quite quickly. An assembly with only Amber LEDs shall be used as an example. The Amber LED arrives from the manufacturer sorted by five flux values which may be identified with the labels V, W, X, Y, and Z. The variation across each flux bin can be ±15% or more. The dominant wave length may vary ±2.5 nm and may be broken into five bins labeled 1, 2, 3, 4, and 5. Five additional bins are created based on Forward Voltage (V_{f}) values varying ±5% and labeled a, b, c, d, and e. The result of all this sorting is that the Amber LEDs arrive at the assembler sorted into 5*5*5 or 125 possible bin locations. A bin of Amber LEDs might be labeled as a W4e; W specifying its flux range, 4 specifying its dominant wavelength, and an e specifying its Forward Voltage.

The LED assemblies can be fabricated using recipes of LEDs from the different bins of Amber LEDs. Each recipe contains the acceptable bin code or bin codes for each LED location within the electronic carrier of the LED light engine assembly design. Acceptable recipes are engineered prior to fabrication to an output that is acceptable to the customer's required optical parameters. The acceptable recipes are determined using optical performance calculations and verified experimentally. With a large number of LEDs in the assembly and a large variation of the optical output within a bin, it becomes increasingly difficult to assure the optical output of the entire assembly is acceptable to the customer—even with a recipe.

There are generally a number of acceptable recipes for each product. Having a number of recipes allows the assembler the flexibility to build the assembly in several different ways to account for inventory variations of the different bins of LEDs. However, even with a number of acceptable recipes for each product design, inventory management of the bin contents in high volume production can be a challenge to the assembler. Conversely, it is sometimes a challenge to find an acceptable recipe of LED bins with an existing inventory of bin quantities.

The above example used a simple LED assembly with only one color LED. The complexity of the recipes increases multifold when a design involves several different color LEDs and the recipes involve pulling LEDs from bins of several different base colors. In reality, multiple color LED light engine assemblies have been marginally successful. The accuracy issue of a single color becomes multiplied into a larger problem; the end result may be unacceptable color rendering. In summary, binning has allowed volume production of acceptable single color LED light engine assemblies. However, binning for single color assemblies lacks flexibility for manufacturing and can produce light output outside the range of acceptability. Binning becomes difficult or impossible to manage in multiple color LED assemblies and the resulting product is generally unacceptable.

The process of the present invention addresses such drawbacks by measuring a baseline optical performance of each unique, individual LED light engine assembly at the time of manufacture to quantify the exact color and intensity of the output, as discussed in further detail below. The quantified values of the baseline measurement of the color are then stored within the LED assembly and available to the system for compensation to the driving input parameters to produce an accurate and repeatable output throughout the life of the system.

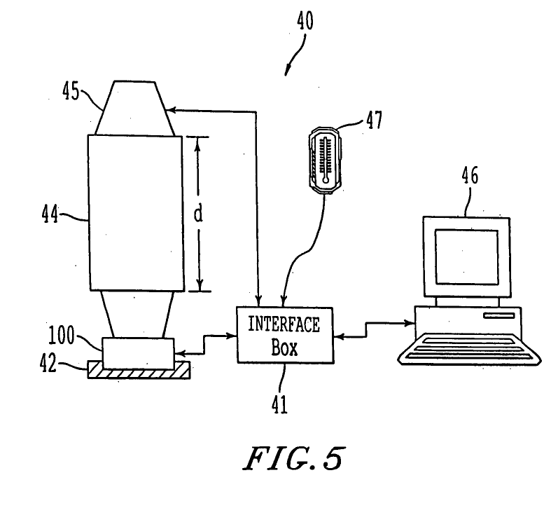

The present inventor developed a process shown in FIG. 4 that uses a test system 40 of FIG. 5. The process of FIG. 4 is performed after assembly of all LEDs and other control electronics but prior to shipment at the manufacturing facility.

In the process each individual LED assembly 100 is loaded onto a manufacturing test system 40 (see FIG. 5) at the beginning of the process, step S111 (see FIG. 4). The test system 40 includes a holder 42 for constraining the LED assembly 100 a fixed distance, d, from an optical measurement instrument 45. A shield 44 directs the light, and prevents stray light entry to the optical measurement instrument 45.

The test system 40 also includes control electronics as well. The control electronics are divided between a customized interface box 41 and the internal circuitry of a customized computer or workstation 46. The test system 40 control electronics include a measurement device for measuring the current temperature, a control device for controlling the LEDs, a measurement device for measuring voltage, and a device for writing data to a memory of the LED assembly, which can be accommodated in the interface box 41, the workstation 46, or on control electronics internal to the LED assembly 100.

After loading the LED assembly 100 into the test system 40, the process directs the control circuitry to drive all of the Red LEDs and only the Red LEDs, step S112. The control circuitry for this process can either be internal to the LED assembly 100 or internal to the test system controller workstation 46. The allRed output is then measured in step S113 with the optical measurement device 45, which for example may include a spectrophotometer. The CIE coordinates for the allRed output and the forward voltage at the allRed are measured in step S113. Step S114 is similar to step S112 except that only all the Green LEDs are driven by the control circuitry. The CIE coordinates of the output for allGreen and the forward voltage for allGreen are measured in step S115 by the optical measurement device 45. Process step S116 is also similar to step S112 except that only all the Blue LEDs are driven by the control circuitry. Step S117 measures the allBlue optical output and the allBlue forward voltage. The steps S112, S114, and S116 may be easiest to implement if all the Red, Green, and Blue LEDs are driven at 100% maximum input condition. However, because LED flux output is mathematically related to its input current, the processes could be implemented with proportionately lower inputs. All optical measurements are preferably taken after the system has reached a steady state. Alternatively, a varying pulse width can be utilized to drive the LEDs and steady state output performance can be extrapolated from there. Steps S113, S115, and S117 could be implemented with any appropriated Color Coordinate System as described below.

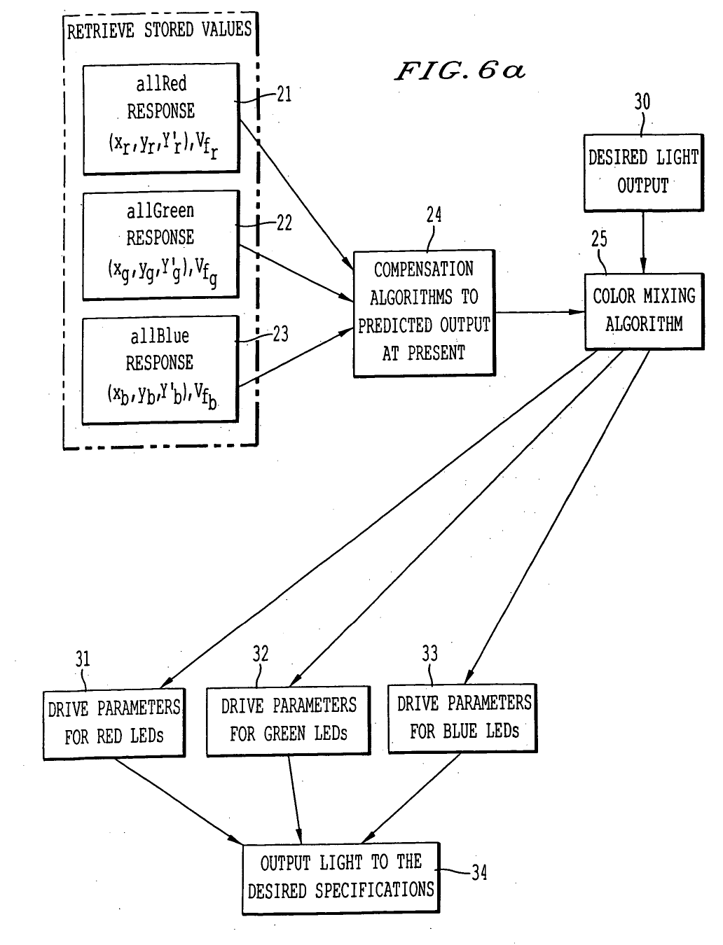

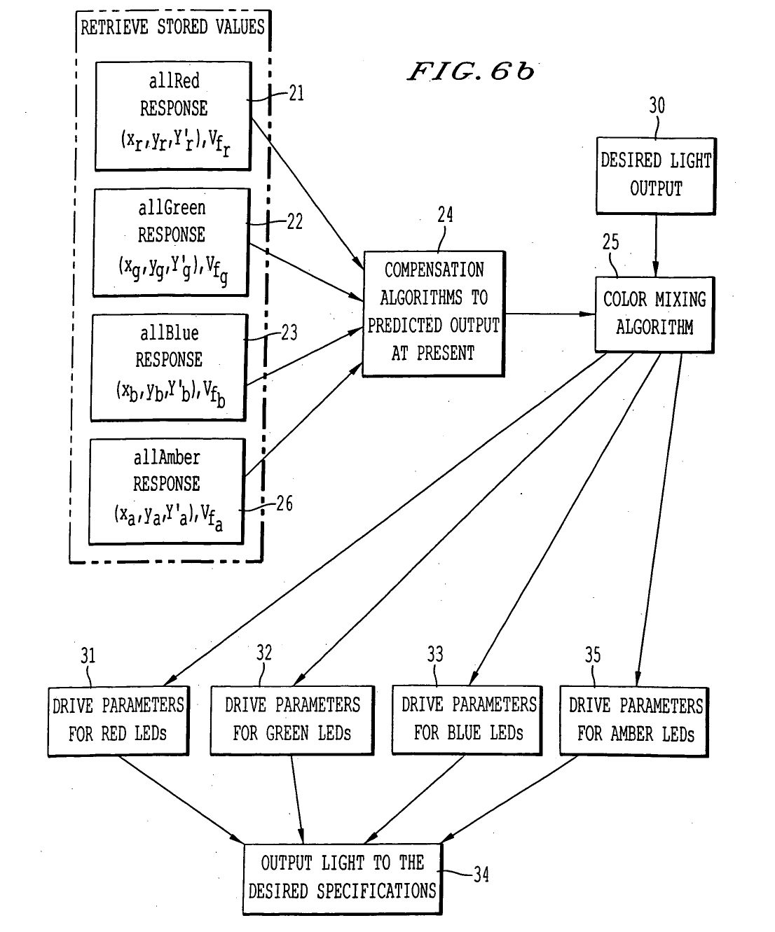

Temperature and/or other relevant environmental data are then measured in step S118 using a temperature measurement device 47. The environmental data is measured to indicate the environmental conditions which result in the measured outputs of the LEDs. For example, LED output will vary based on temperature, so it is relevant to know for the measured optical outputs of the Red, Green, and Blue LEDs in steps S113, S115, and S117 what the temperature is at the time of measurement. The environmental measurement of step S118 is then used in a compensation algorithm 24 to control driving of the LEDs, as discussed below with reference to FIG. 6. The algorithm accommodates the optical output change resulting from intensity changes and dominant wavelength changes with temperature. Future changes away from the baseline environment can be corrected by the below discussed compensation algorithm 24.

All of the measured information is then stored internal to the LED assembly 100 in step S119. The stored information is represented by the following variables described below, using CIE values (x, y, Y), V_{f} for forward voltage, and T for temperature.
(xᵣ, yᵣ, Yᵣ′) V_{fr}, (x_{g}, y_{g}, Y_{g}′) V_{fg}, (x_{b}, y_{b}, Y_{b}′) V_{fb}, T

All of the stored information can be written in step S119 as described or alternatively the stored information could be written to a memory device of the LED assembly immediately after they are acquired in steps S113, S115, and S117. This alternative is shown by the dashed lines in FIG. 4.

Additional information about the performance of the unique light engine “as manufactured” can be stored internal to the system in step S119, e.g., possibly the date and time of the measurements or the serial number of the product. Storage of these initial measurements external to the system can also be performed. Duplicate data external to the LED assembly could be used in the repair or rework of an assembly or utilized for statistical analysis of the production variability. The process completes in step S120 by unloading the LED assembly 100 from the test system 100 and proceeding with usage of the LED light engine assembly 100.

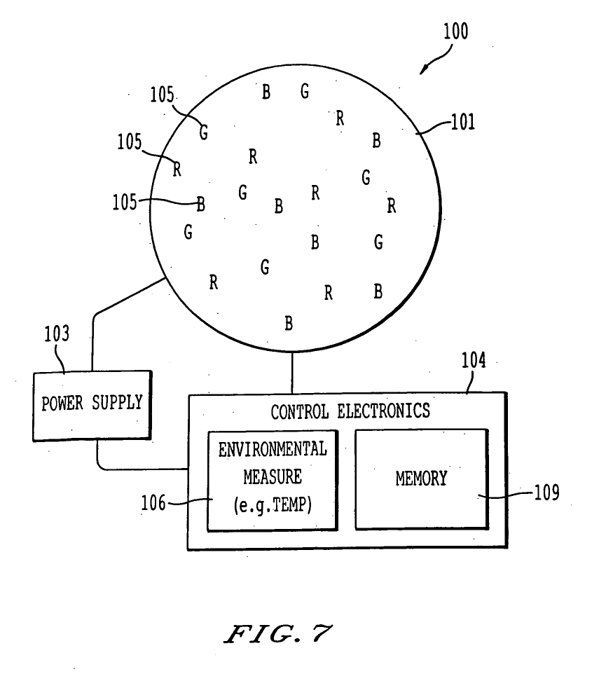

With the above process, the present invention characterizes and records the LED assembly's specific light output information at the time of manufacture to record baseline color output of the LED assembly, which information is then used in an overall process of generating compensated light output in an LED assembly in FIGS. 6 and 7. By so doing, an exact baseline of the displayed color can be made available to algorithms for color optimization.

FIGS. 6a and 6b and 7 show an LED assembly of the present invention which stores the data generated by the process in FIG. 4, and which utilizes such data to generate an enhanced desired light output of the proper color. FIG. 7 shows a structure of an LED assembly 100 including LEDs 105 in LED light 101 and power supply 103, in the present invention, and FIGS. 6a and 6b show control operations performed in that LED assembly 100.

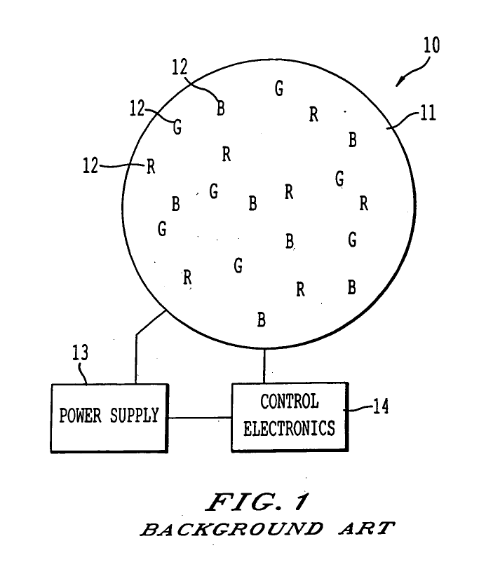

As shown in FIG. 7, the LED assembly 100 of the present invention is similar to that in the background art of FIG. 1, except the LED assembly 100 of the present invention includes enhanced control electronics 104 including an environmental sensor 106 and memory 109. The memory 109 stores the data noted in step S119 in FIG. 4.

There are many ways that the information can be stored in the system, but one feature is that the “as manufactured” output information remains available to the optimization algorithms throughout the life of the light engine. The internal method of storing the information can be any of a number of memory devices. A Read Only Memory (ROM), a Programmable Read Only Memory (PROM), an Erasable Programmable Read Only Memory (EPROM), an EEPROM (an Electrically Erasable Programmable Read Only Memory), a Flash EPROMs, etc. can be used, as the memory 109.

The control electronics 104 in FIG. 7 performs the operation shown in FIGS. 6a, 6b, as now discussed in further detail below.

A first embodiment of the overall control operation of the LED assembly 100 of the present invention as shown in FIG. 6a is to utilize the stored baseline light output data of the Red LEDs, Green LEDs, and Blue LEDs that form the LED light 101 in conjunction with the stored environmental data, perform compensations based on the measured output of those lights and based on measured environmental values, and to output a desired light output.

In the operation, stored values for the allRed response, allGreen response, and allBlue response are retrieved in processes 21-23. Those values correspond to the values stored in step S119 in FIG. 4. That retrieved information in processes 21-23 can be utilized by compensation and color mixing algorithms to allow a custom color generation to be realized.

More specifically, the retrieved stored values from processes 21-23 are provided to a process 24 that runs a compensation algorithm to predict an output under current environmental conditions based on the retrieved stored values. An output from that compensation algorithm 24 is then provided to a color mixing algorithm 25. The color mixing algorithm 25 receives as an input a desired light output from a process 30. Thereby, the color mixing algorithm 25 receives an indication as to a desired light output and can modify the color mixing to achieve that desired light output. The color mixing algorithm 25 then controls driving of parameters for the Red LEDs, Green LEDs, and Blue LEDs in processes 31-33 to output light of a desired specification in process 34.

The compensation algorithm 24 and color mixing algorithm 25 are the control algorithms to achieve a desired color output and are either hard programmed with electronic circuitry or soft programmed with custom software internal to the control electronics 104 of the LED light engine assembly 100. The color mixing algorithm 25 adjusts the duty cycle (D) and other parameters of each LED in processes 31-33, effectively modifying the percentages of each base color to customize the color display. The duty cycle can be adjusted using any number of control techniques—including Pulse Frequency Modulation, Pulse Position Modulation, Amplitude Modulation, Phase Shift Modulation, and Pulse Width Modulation (see e.g., U.S. Pat. No. 6,016,038 to Color Kinetics).

Operating the compensation algorithm 24 and color mixing algorithm 25 in combination with retrieving the stored optical parameters in processes 21, 22, and 23 resolves many of the performance issues of LED light engine assemblies. The compensation algorithm 24 can be applied to account for temperature variations in the optical output. Similarly, the lifetime degradation of LEDs can be overcome algorithmically in the compensation algorithm 24. That is, the compensation algorithm 24 can consider current environmental conditions, aging of the LED, etc., and can compensate the light output of the LEDs for such current conditions. For example light output of LEDs drops with temperature. Therefore, if the current temperature at the LED assembly 100 is higher than when the LEDs were tested, i.e., higher than the temperature stored in step S119 in FIG. 4, then the compensation algorithm 24 can control to increase the driving power of each of the LEDs to compensate for the decreased intensity resulting from the increased temperature. Similarly, the compensation algorithm 24 can factor the age of the LEDs and increase the driving current (I) to the LEDs 105 as the LEDs 105 age. The compensation algorithm 24 can perform other compensations based on other environmental conditions, for example humidity, and other factors as needed.

Further, difficulties of recipes and binning can be accommodated by appropriate application of the color mixing algorithm 25. The compensation algorithm 24 and color mixing algorithm 25 can provide for calculations of the compensated light rendering process because of an accurate known starting point. That is accomplished in the process of the present invention.

A specific non-limiting example of specifics of color mixing algorithm 25 that can be implemented in the present invention is as follows.

The color mixing algorithm 25 begins with the target color specified for display.
Targeted Color Coordinates (xₜ, yₜ, Yₜ′) (151)

The CIE Chromaticity coordinates (x, y, Y′) of the spectral input for allRed, allGreen, and allBlue are also known to the algorithm, see steps S113, S115, S117 in FIG. 4.
Measured (xᵣ, yᵣ, Yᵣ′), (x_{g}, y_{g}, Y_{g}′), (x_{b}, y_{b}, Y_{b}′) (152)

The desired output is the duty cycle of the allRed, allGreen, and allBlue LED assemblies for display of the target color and the driving current.
Find (Dᵣ_{ₜ}′, D_{g}_{ₜ}′, D_{b}_{ₜ}′) and I (153)

The derivation and details for a non-limiting implementation of the color mixing algorithm 25 is as follows.

First, z need not be given for any of the colors because of the following defining equation.
x+y+z=1 (154)
z=1−x−y

Linear proportionality constants (weighting factors) for the relationship between the output intensity and y coordinate for allRed, allGreen, and allBlue are calculated.
mᵣ=(Yᵣ′/yᵣ) (155)
m_{g}=(Y_{g}′/y_{g})
m_{b}=(Y_{b}′/y_{b})

The proportionality constants are used to calculate the CIE coordinates of the combination of allRed, allGreen, and allBlue—ideally a true white color.

$${x}_{w} = \frac{{x}_{r} {m}_{r} + {x}_{g} {m}_{g} + {x}_{b} {m}_{b}}{{m}_{r} + {m}_{g} + {m}_{b}} \\ {y}_{w} = \frac{{y}_{r} {m}_{r} + {y}_{g} {m}_{g} + {y}_{b} {m}_{b}}{{m}_{r} + {m}_{g} + {m}_{b}} \\ {Y}_{w}^{′} = {Y}_{r}^{′} + {Y}_{g}^{′} + {Y}_{b}^{′} \qquad ( 156 )$$

CIE coordinates are converted to Tristimulus values. Tristimulus values are a similar coordinate system for describing the color that is not normalized. The relationship between the 2 coordinate systems is defined by the following equations (157).
Y=Y′ x=X/(X+Y+Z) y=Y/(X+Y+Z) z=Z/(X+Y+Z) (157)

The following general equations can be quickly derived from equations (154) and (157) above.

$$\frac{X}{Y} = \frac{x}{y} \\ \frac{Z}{Y} = \frac{z}{y} \\ \frac{Z}{Y} = \frac{( 1 - x - y )}{y} \qquad ( 158 )$$

The general equations (158) above create the specific equations for the Tristimulus values X, Y, Z for allGreen, allRed, allBlue and the resultant white shown as equations (159). It is important to note that this white may not necessarily appear white. The degree to which it is truly white will depend on how evenly balanced the 3 stimulus colors are around the center coordinates of white (0.333, 0.333, 0.333).

$${X}_{r} = \frac{{x}_{r} {Y}_{r}^{′}}{{y}_{r}} {Y}_{r} = {Y}_{r}^{′} {Z}_{r} = \frac{( 1 - {x}_{r} - {y}_{r} ) {Y}_{r}^{′}}{{y}_{r}} \\ {X}_{g} = \frac{{x}_{g} {Y}_{g}^{′}}{{y}_{g}} {Y}_{g} = {Y}_{g}^{′} {Z}_{g} = \frac{( 1 - {x}_{g} - {y}_{g} ) {Y}_{g}^{′}}{{y}_{g}} \\ {X}_{b} = \frac{{x}_{b} {Y}_{b}^{′}}{{y}_{b}} {Y}_{b} = {Y}_{b}^{′} {Z}_{b} = \frac{( 1 - {x}_{b} - {y}_{b} ) {Y}_{b}^{′}}{{y}_{b}} \\ {X}_{w} = \frac{{x}_{w} {Y}_{w}^{′}}{{y}_{w}} {Y}_{w} = {Y}_{w}^{′} {Z}_{w} = \frac{( 1 - {x}_{w} - {y}_{w} ) {Y}_{w}^{′}}{{y}_{w}} . \qquad ( 159 )$$

The same equations can be used to convert the given CIE values of the target color to (xₜ, yₜ, Yₜ′) to Tristimulus values of (Xₜ, Yₜ, Zₜ) as below.

$${X}_{t} = \frac{{x}_{t} {Y}_{t}^{′}}{{y}_{t}} {Y}_{t} = {Y}_{t}^{′} {Z}_{t} = \frac{( 1 - {x}_{t} - {y}_{t} ) {Y}_{t}^{′}}{{y}_{t}} \qquad ( 160 )$$

Scale Factors (Sᵣ, S_{g}, S_{b}) are required for the transformation matrix M and are calculated from the known values on the right hand side of equation (160) as follows.

$$\begin{matrix}[ \begin{matrix}{S}_{r} & {S}_{g} & {S}_{b}\end{matrix} ] = {[ \begin{matrix}{X}_{w} & {Y}_{w} & {Z}_{w}\end{matrix} ] [ \begin{matrix}{X}_{r} & {Y}_{r} & {Z}_{r} \\ {X}_{g} & {Y}_{g} & {Z}_{g} \\ {X}_{b} & {Y}_{b} & {Z}_{b}\end{matrix} ]}^{- 1} & ( 161 ) \\ [ M ] = [ \begin{matrix}{S}_{r} {X}_{r} & {S}_{r} {Y}_{r} & {S}_{r} {Z}_{r} \\ {S}_{g} {X}_{g} & {S}_{g} {Y}_{g} & {S}_{g} {Z}_{g} \\ {S}_{b} {X}_{b} & {S}_{b} {Y}_{b} & {S}_{b} {Z}_{b}\end{matrix} ] & ( 162 )\end{matrix}$$

The [Rₜ Gₜ Bₜ] for the target color is the amount of Red, Green, and Blue in the target color and could be used to describe the color if an RGB specification system were utilized as follows.
[Rₜ Gₜ Bₜ]=[Xₜ Yₜ Zₜ] [M]⁻¹ (163)

The duty cycle, D, of each of the colors is calculated below. For ease of implementation, one of the three duty cycles for allRed, allBlue, or allGreen is always defined as 100%. The other two duty cycles are scaled to keep similar RGB proportions.
Dᵣ_{ₜ}=Rₜ/max(R_{g},Gₜ,Bₜ)D_{g}_{ₜ}=Gₜ/max(Rₜ,Gₜ,Bₜ)D_{b}_{ₜ}=Bₜ/max(Rₜ,Gₜ,Bₜ) (164)

Further simplifying for the instance when [Sᵣ, S_{g}, S_{b}]=[1.0, 1.0, 1.0], the instance is relevant when the design requirements state that the combination of allRed, allGreen, and allBlue does not have to be a pure white.

$$c = {x}_{b} ( {y}_{g} - {y}_{r} ) + {x}_{g} ( {y}_{r} - {y}_{b} ) + {x}_{r} ( {y}_{b} - {y}_{g} )$$

$${R}_{t} = - \frac{{y}_{r} ⌊ {x}_{b} ( {y}_{t} - {y}_{g} ) + {x}_{t} ( {y}_{g} - {y}_{b} ) + {x}_{g} ( {y}_{b} - {y}_{t} ) ⌋}{{y}_{t} \cdot {Y}_{r}^{′} \cdot c}$$

$${G}_{t} = \frac{{y}_{g} [ {x}_{b} ( {y}_{t} - {y}_{r} ) + {x}_{t} ( {y}_{r} - {y}_{b} ) + {x}_{r} ( {y}_{b} - {y}_{t} ) ]}{{y}_{t} \cdot {Y}_{g}^{′} \cdot c}$$

$${B}_{t} = \frac{{y}_{b} [ {x}_{t} ( {y}_{g} - {y}_{r} ) + {x}_{g} ( {y}_{r} - {y}_{t} ) + {x}_{r} ( {y}_{t} - {y}_{g} ) ]}{{y}_{t} \cdot {Y}_{b}^{′} \cdot c}$$

$${D}_{{r}_{t}} = {R}_{t} / max ( {R}_{t} , {G}_{t} , {B}_{t} )$$

$${D}_{{g}_{t}} = {G}_{t} / max ( {R}_{t} , {G}_{t} , {B}_{t} )$$

$${D}_{{b}_{t}} = {B}_{t} / max ( {R}_{t} , {G}_{t} , {B}_{t} )$$

The present equations have only related to the generation of the color and not to the intensity of the color. The target color intensity is expressed by Yₜ′. Adjustments for intensity are calculated as follows:
Yₜₒₜₐₗ′=Yᵣ′+Y_{g}′+Y_{b}′

I_{ref} is the driving current specified by the LED manufacturer and used in the manufacturing testing process to generate the stored values for processes 21, 22, and 23 of FIG. 6.
Case 1: If Yₜₒₜₐₗ′≧Yₜ′ then the following equations apply. The duty cycles are downscaled appropriately to account for the intensity.

$${D}_{{r}_{t}}^{′} = \frac{{Y}_{t}^{′}}{{Y}_{total}^{′}} {D}_{{r}_{t}}$$

$${D}_{{g}_{t}}^{′} = \frac{{Y}_{t}^{′}}{{Y}_{total}^{′}} {D}_{{g}_{t}}$$

$${D}_{{b}_{t}}^{′} = \frac{{Y}_{t}^{′}}{{Y}_{total}^{′}} {D}_{{b}_{t}}$$

$$I = {I}_{tested}$$
Case 2: If Yₜₒₜₐₗ′<Yₜ′ then the following equations apply. The driving current is upscaled appropriately to accommodate the additional required brightness.

$${D}_{{r}_{t}}^{′} = {D}_{{r}_{t}}$$

$${D}_{{g}_{t}}^{′} = {D}_{{g}_{t}}$$

$${D}_{{b}_{t}}^{′} = {D}_{{b}_{t}}$$

$$I = \frac{{Y}_{t}^{′}}{{Y}_{total}^{′}} {I}_{tested}$$

The targeted color is therefore displayed for both case 1 and case 2 using the duty cycles (Dᵣ_{ₜ}′, D_{g}_{ₜ}′, D_{b}_{ₜ}′) and the driving current I.

FIG. 6b shows a modification of the embodiment of FIG. 6a, which can be applied to a device including different colored LEDs of Red LEDs, Blue LEDs, Green LEDs, and Amber LEDs. That is, instead of having a system with only three colors of Red, Blue, and Green, a system can incorporate four colors of Red, Blue, Green, and Amber. In those circumstances the operations shown in FIGS. 3a, 3b, and 4 will also perform operations directed to the Amber LEDs similarly as for the Red, Green, and Blue LEDs. As a result, measured optical values stored in memory will also include data for the Amber LEDs, and thus in FIG. 6b an additional operation of retrieving the all Amber response in process 26 is executed, and then in process 34 the duty cycle and other parameters of the Amber LEDs are also adjusted similarly as for the Red, Green, and Blue LEDs.

The present invention is not even limited to such an embodiment with four colors, but any number and colors can be used in any desired combination.

A previous example assembly is now used for the discussion on the present invention. Assume a previous assembly includes several Red LEDS, several Green LEDs, and several Blue LEDs. Additionally, for ease of explanation the combined output from all Red LEDs shall be referred to as the allRed Output. If there is only one Red LED then the output of the Red LED and allRed will be equal. Similarly, the display of all Green LEDs shall be referred to as allGreen and all Blue LEDs as allBlue.

The process of the present invention allows the generation of an exact, known, starting point or baseline of the color output and internal storage of that known starting point within the system. The light output of a specific LED assembly is initially stored internal to the assembly on an appropriate memory device. This initial point can be utilized by an appropriate compensation algorithm 24 and an appropriate color mixing algorithm 25 at any later point in time to produce a desired color match.

The process of the present invention involves storing the specific light output description internal to the LED light engine assembly, by the process of FIG. 4, which is then used for custom color rendering. Then, in operation of the LED assembly 100 the stored data are retrieved in processes 21, 22, and 23 of the compensated light process of FIG. 6. By so doing, an exact baseline of the displayed color can be made available to the compensation algorithm 24 and color mixing algorithm 25. The processes S113, S115 and S117 of FIG. 4 generate the CIE coordinates of allRed, allGreen and allBlue, and the processes 21, 22 and 23 of FIG. 6 utilize the CIE coordinates of allRed, allGreen and allBlue.

The allocated memory 109 for storing the initial optical performance information can be a dedicated single component. Alternatively, the information can be combined with other system information and added to the storage components that already reside in the system. For instance, the stored output of the manufacturing process of the present invention could be added to the firmware of the control system and stored on the same physical device as the firmware.

Color specifications in the process of FIG. 4 can be transmitted using the CIE Color Coordinate System. There are other universal color coordinate systems that are device independent that could also be utilized to quantify the light source. The Lab Model uses Lightness (L), an (a) coordinate along a green to red spectrum, and (b) coordinate along a blue to yellow spectrum. The Munsell Color System uses three coordinates of Hue (H), Value (V), and Chroma (C). The present invention does not exclude the usage of any of these universal color coordinate systems, but that the CIE System is believed to be the most effective at communicating an exact color.

If another coordinate system is used then the measured and stored values would not be exactly the variables listed below
(xᵣ, yᵣ, Yᵣ′) V_{f}, (x_{g}, y_{g}, Y_{g}′) V_{f}_{_{g}}, (x_{b}, y_{b}, Y_{b}′) V_{b}_{_{b}}, T

Conceptually, they would be similar values describing the color but in a new coordinate system. For instance for an Lab Model they would most likely be
(Lᵣ, aᵣ, bᵣ) V_{f}_{ᵣ}, (L_{g}, a_{g}, b_{b}) V_{f}_{_{g}}, (L_{b}, a_{b}, b_{b}) V_{b}_{_{b}}, T

And for the Munsell System they might be
(Hᵣ, Vᵣ, Cᵣ) V_{f}_{ᵣ}, (H_{g}, V_{g}, C_{g}) V_{f}_{_{g}}, (H_{b}, V_{b}, C_{b}) V_{b}_{_{b}}, T

There are a number of different Color Coordinate System standards based around the 3 colors of Red, Green, and Blue. Examples of standard RGB color spaces include ISO RGB, sRGB, ROMM RGB, Adobe RGB, Apple RGB, and video RBG spaces (NTSC, EBU, ITU-R BT.709). But none of these standards are universal, and there may never be a universal RGB standard because the needs of different applications (scanners, digital cameras, monitors, printers) are different. There are also CMYK color standards based on proportions of Cyan, Magenta, Yellow, and Black. The CMYK standards suffer from the same lack of universality disadvantage as the RGB standards. Any of these standards could be used for the color description of the present invention, but the CIE Color Coordinate System may be the preferred implementation because of its more universal acceptance.

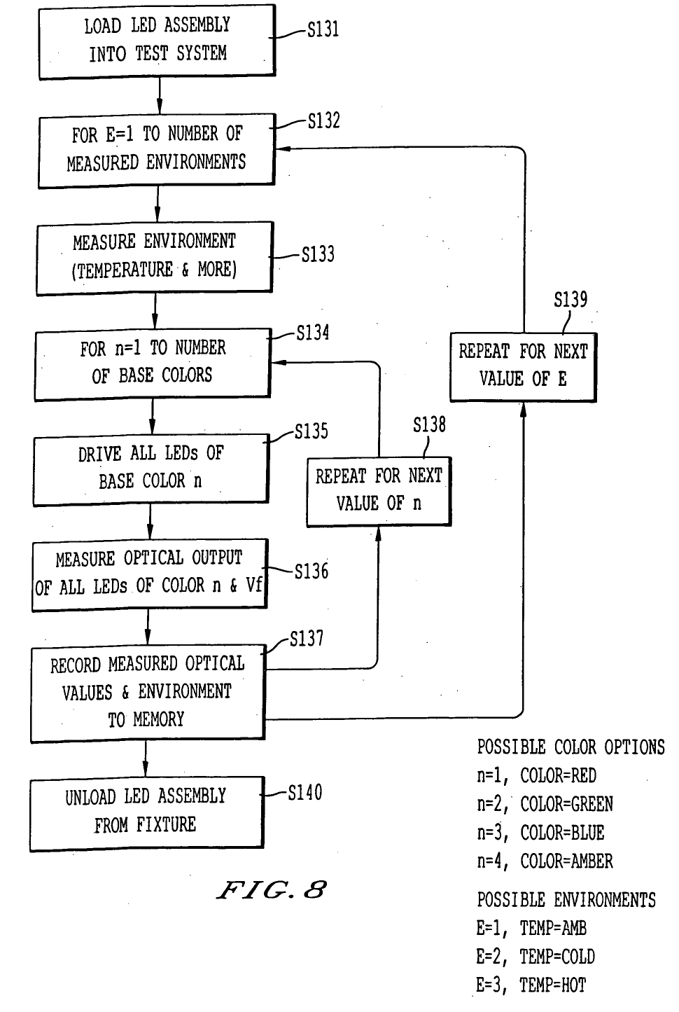

The process described above with respect to FIG. 4 shows obtaining data for a system with up to three colors, and FIG. 6b shows application for a system with up to four colors. There is no requirement that the system include only these colors but any number of colors can be incorporated. A more generalized process that can be performed in the present invention is shown in FIG. 8, which essentially achieves the same results as the process of FIG. 4, but which can be applied to as many colors as desired with different environmental conditions.

The more generalized process of FIG. 8 has the same goal as the process of FIG. 4. Step S131 begins the generalized process by loading the LED light engine assembly 100 into the test system 40. Step S132 is the beginning of an “outer loop” iteration function designed to quantify the relevant, baseline optical properties across a number of environments. If only one environment is baselined as in the specific example above, then the number of environments is one and the iteration loop is only performed once. The environments can either be controlled, as in a thermal and humidity test chamber, or uncontrolled, as the LED die temperature at the time of manufacture. Relevant environmental variations might be temperature, humidity, system “on time”, altitude, or any other environmental condition. Step S133 quantifies the relevant environmental condition either using an environmental sensor, e.g. temperature sensor 47. Step S134 begins another “inner loop” iteration function for each base color. In the specific examples, the number of base colors is three or four (Red, Green, Blue, and optionally Amber) and the iteration loop is performed three or four times.

Step S135 drives all of the LEDs of a single base color. In general the LEDs are all driven with 100% input current and measured. Other values of inputs could be used with linear, logarithmic, or other appropriate scaling applied in the subsequently executed algorithms. In step S136 the light output and forward voltage is measured and quantified for the combination of base color and environmental condition being tested. Step S137 records the measured values of step S136 to memory 109. The storage to memory in step S137 could occur after each measurement is taken or collectively after all measurements have been taken. The “inner loop” iteration function of step S138 repeats the process for each base color. The “outer loop” iteration function of step S139 repeats the process for each environmental condition. Each environmental condition for example could be temperature of an ambient temperature value, a hot temperature value, and a cold temperature value. The “inner loop” and “outer loop” functions can be swapped as long as all of the base colors and environments are quantified. Step S140 concludes the process by removing the LED light engine assembly 100 from the test system 40. At the conclusion of step S130 the internal memory 109 now includes baseline optical performance of the specific LED light engine assembly.

By including the baseline optical performance of the unique LED light engine assembly internal to the control electronics, improvements can be made in the manufacturing, the functioning, and the quality of light output of an LED assembly. Referring to FIG. 7, each LED light engine assembly has in memory 109 the starting point of the optical output of its installed LEDs 105 under known environmental conditions. Without the stored values generated by the processes 21, 22, 23, 26 of the present invention, an assumed value, like the average optical output of a set of LEDs, would be required for the starting point of the compensation algorithm 24 and the color mixing algorithm 25. The result of using the generated set of stored values is a considerably improved process for the following reasons: an infinite number of targeted output colors can be rendered by utilizing the known starting point of the unique LED assembly and applying color mixing algorithms; accuracy of the rendered color is improved because the color mixing algorithms begin with the known starting point of optical color performance; repeatability of the target color is improved because compensation for intensity degradation over a product lifetime can be applied from the known starting point; color rendering is more repeatable because compensation to account for wavelength variations and intensity variations with temperature can be applied from the known starting point; recipes and binning can be reduced or eliminated because the LED light engine assembly can perform algorithms to compensate for the manufacturing variations of the individual LEDs.

The end result is an LED light engine assembly capable of rendering more colors accurately and repeatably while improving costs and manufacturability.

The features of the embodiment of the present invention noted above are directed to manufacture an LED assembly in which the inputs of the color mixing algorithm 25 utilizes the retrieved stored values 21-23 and 26 input into compensation algorithms 24 to predict output.

However, in a further embodiment of the present invention the input to the color mixing algorithm 25 can be from a different source, and can undergo further compensation prior to the signal being input into the color mixing algorithm 25.

Such a further embodiment of the present invention is shown in FIG. 8B.

In FIG. 8B the color mixing algorithm 25 can receive an input signal from different initial LED spectral response options and after different compensation options.

As discussed in further detail now, the LED spectral response values are a starting point for an input signal to the color mixing algorithm 25. The embodiment shown in FIG. 6b corresponds to the LED spectral response being measured at assembly, noted as 213 in FIG. 7. That is, the measured at assembly 213 LED spectral response corresponds to the retrieved stored values 21, 22, 23, and 26 in FIG. 6b. As noted above, utilizing such measured values at assembly requires a pre-testing of the LEDs in the assembly and storing data of different responses of the LEDs. Certainly, simpler options could, however, also be implemented.

In a simplest process an LED spectral data from a supplier 211 can be utilized. Such data could be the bin data from the LED manufacturer. This is of course the simplest option as it relies on the supplier to provide the relevant data. Of course this option is probably also the least reliable because of the difference in the LEDs even in the binning process as discussed above.

A further alternative is to provide an average LED spectral data 212 based on experimental data about the LEDs or group of LEDs. Currently, LED technology may not yield an acceptable output of the average data, but even though the variability from any one LED to a next LED may be quite large, the variability of large groups of LEDs diminishes with the size of the groups. With improvements to LED technology and the uses of larger groups of LEDs, the average LED spectral input 212 may yield an acceptable starting LED spectral response.

After the LED spectral response different compensation options can be utilized.

The simplest option is no compensation 221 and may be relevant shortly after an LED light engine assembly has been put into service and a temperature is close to a testing temperature. The testing temperature could be the temperature of a supplier testing, average testing, or of the assembly testing depending on the choice of spectral inputs 211, 212, and 213. The no compensation 221 option is the simplest but will not provide the highest level of performance.

A further compensation option is a time compensation 222 on spectral values to compensate for the effects of time based degradation. That is, LEDs degrade over time as is known, and such time degradation is typically logarithmetic and predictable. Based on the mathematical relationship of degradation in intensity and the usage time of the LED light engine assembly, an LED stimuli can be converted to new predicted LED stimuli at a current time period. As time progresses the intensity of the light output decreases and a typical LED degradation over a first year may be 20%-30%, which is significant enough to warrant a correction. This time compensation option 222 does not provide a temperature compensation.

A next compensation option is a temperature compensation 223 to correct the effects of temperature based degradation. Temperature has two different effects on LED light output. The first effect is on the light output and is a quadratic relationship in the area of interest. Temperature is an independent variable. An output intensity is a dependent variable of the quadratic equation. The coefficients of the quadratic equation vary with different base color LEDs because a semi-conductor compound is different with each base color. The base color can be determined from the CIE coordinates of the spectral response or from the wavelength by either a look-up table or it can be pre-programmed into electronics. Coefficients of the quadratic equation can then be measured by the semi-conductor manufacturer or assembler and are constant over time and temperature. The result is an algorithm that relates to changes in temperature at the LED light engine to drops in output light intensity. If I is normalized to 1 at room temperature and temperature is expressed as ° C., then a sample equation for a InGaN LED device is:
I=−0.000004T².0.029T+1.0477.

A second effect of temperature that is compensation with the temperature compensation option 223 is on wavelength. A base color can be determined from a wavelength or CIE coordinates by either a look-up table or it can be programmed into electronics. Temperature increases also increase the peak wavelength and increase the breadth of the wavelength response. Wavelength increases linearly with temperature increases in the region of interest. The rate of change, K, can be approximately constant for each base color.

A further final compensation option which is the most complex but which provides the highest quality results is the time and temperature compensation 224 to correct the spectral input for both time based degradation to output light intensity and temperature related effects described above. The time and temperature compensation 224 option combines the effects of time compensation 222 option and temperature compensation 223 option.

The output of the compensation option is then provided to the color mixing algorithm 25. Such options allow providing the most accurate representation of LED stimuli for the starting point for the color mixing algorithm 25. Utilizing the time and temperature compensation 224 option will yield the most accurate color rendering as it will correct for both time based degradation and temperature induced changes in light output of an LED.

The above-noted features in the present invention are directed to manufacturing an LED assembly to properly output light. A further feature of the present invention is to insure that a specific desired color of light can be output consistently by an LED light assembly. Such a feature may have particular application for example in architecture, stage, theatrical, live shows, and production lighting. In such applications it may be particularly desirable to insure that light output from an LED light source is of a specific color, and that that specific color is maintained. Such a concept of outputting light of a specific color is often referred to as color rendering.

Color rendering in modern technology was first accomplished as an additive process of Red, Green, and Blue (RGB). Early rendering produced color by combining appropriate amounts of Red, Green, and Blue to display television images. RGB systems are used for both the generation of color and the specification of color. This is an important distinction. RGB systems are commonly used to create a color, but they are also used to specify a color.

The prevailing systems to specify color resulted from the usage of the RGB generation systems. When the color is produced as a combination of RGB, the simplest and easiest way to specify the color is the amount of RGB in the target color. The RGB specification systems, out of ease of implementation and response speed, resulted from the RGB generation systems. But RGB specification systems have deficiencies.

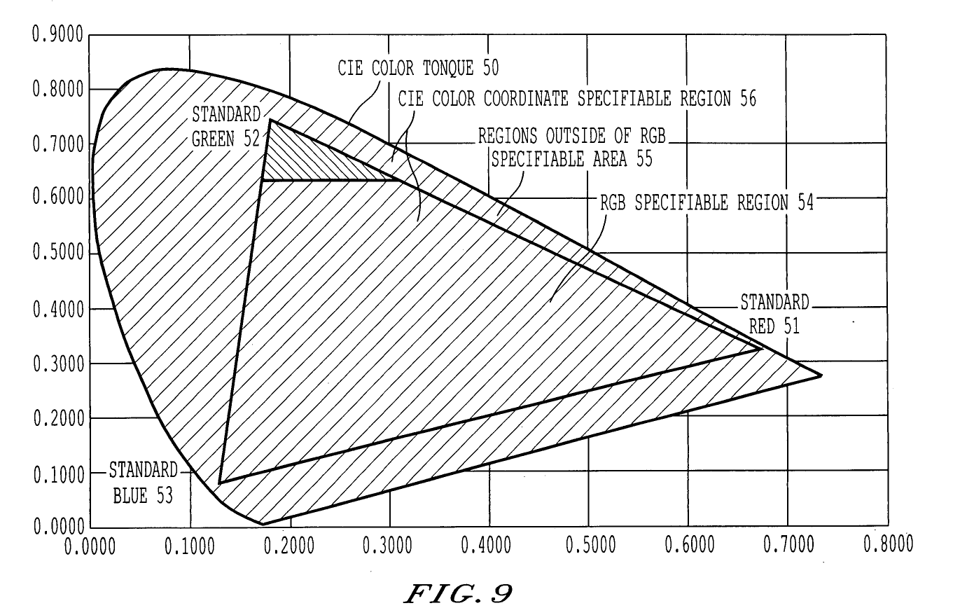

An RGB implementation has a limited range of displayed color. FIG. 9 shows an example RGB color specification on the CIE Chromaticity Chart. All CIE specifiable visible colors are represented by region 56. RGB specifications are limited to colors that can be represented as a combination of Red, Green, and Blue. The RGB specifiable colors are shown in triangle 54. Many colors can be represented by the summation of Red, Green, and Blue inside the triangle 54, but many colors, those outside the triangle, can not. These colors are represented in the surrounding Region Outside of the RGB Specifiable Area 55. The CIE Specifiable Region 56 is the sum of the RGB Specifiable Triangle 54 and the Region Outside the RGB Specifiable Triangle 55. The salient point is that with an RGB color specification system the colors in region 55 can not be generated or specified. With an RGB specification, it is as though the colors of region 55 do not exist.

One further feature in the present invention is to realize a system that allows specifying all such colors in CIE Specifiable Region 56, as discussed further below.

Different RGB standards have been developed for different applications. The primary difference between the RGB standards is the definition of the base colors. The Red defined by one system may be a few shades different from the Red of another system—and likewise for Green and Blue. Examples of standard RGB color spaces include ISO RGB, sRGB, ROMM RGB, Adobe RGB, Apple RGB, and video RGB spaces (NTSC, EBU, ITU-R BT.709). It is unlikely that there will ever be a universal RGB standard because the needs of different applications (scanners, digital cameras, monitors, printers, televisions) are different.

FIG. 10 demonstrates the effect on color rendering of different RGB color specification systems. The RGB Gamut of FIG. 9 is replicated in FIG. 10 and is assumed to be any one of the RGB color specification systems mentioned above. It is labeled RGB Specification System 1 with RGB extents at Standard Red₁, Standard Green₁, and Standard Blue₁. A second RGB Specification System 2 is overlain onto the FIG. 10 with RGB extents at Standard Red₂, Standard Green₂, and Standard Blue₂.

Because of their basis in a standard Red, standard Green, and standard Blue, custom colors specifications using RGB specifications are only as good as the definition of the standard colors. A custom color specified by RGB System 1 as Red 20%, Green 80% and Blue 0% is shown graphically as 46 and is 20% of the traversal along the line interconnecting Standard Green₁ and Standard Red₁. A custom color specified in the same manner with RGB System 2 as Red 20%, Green 80% and Blue 0% is shown graphically as 47 and is 20% of the traversal along the line interconnecting Standard Green₂ and Standard Red₂. Although both colors are specified the same way, the resulting colors 46 and 47 are differentiable because of the different standard Red, Green, and Blue. A custom color of Red 33%, Green 33%, and Blue 33% 48 as specified by RGB System 1 is discernibly different from Red 33%, Green 33% and Blue 33% 49 as specified by RGB System 2. If RGB System 1 is used by a Cathode Ray Tube (CRT) manufacturer and RGB System 2 is used by a Liquid Crystal Display (LCD) manufacturer (R 20, G 80, B 0) will be displayed differently on the CRT monitor than the LCD monitor. The target color is not repeatable. The conclusion from FIG. 10 is that the resultant color output is highly dependent on the RGB standard and is not necessarily repeatable.

The engineering of a color rendering device usually dictates the specific RGB standard. For instance, CRTs for television and computer monitors use a beam splitter to divide white light into its Red, Green, and Blue components. The physics of the beam splitter dictates the CIE Color Coordinate System definition of the Red, Green, and Blue standards for color generation. Liquid Crystal Displays (LCDs) similarly divide each pixel into Red, Green, and Blue sub-pixels. The RGB sub-pixels are created through white light filtering. Similar to CRTs, the design and physics of the filtering process for LCDs mandates the selection of the RGB standards for color generation. The color rendering device design of the beam splitter or the filter, for instance, imposes the RGB standards. Vice-versa, the rendered color output from RGB standards is dependent on the device design.

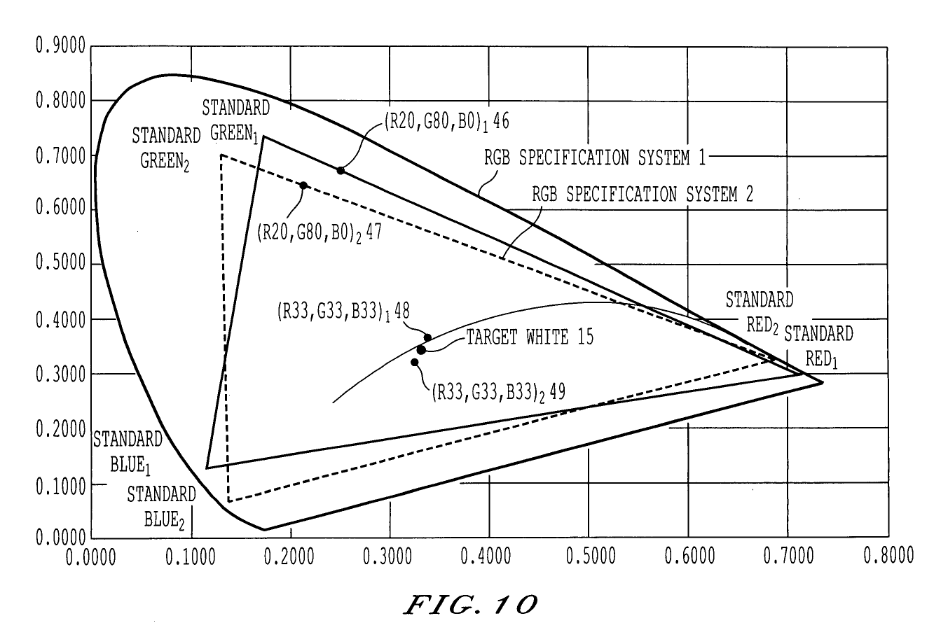

The most common communication protocol for architectural, stage, theatrical, live shows, and production lighting is DMX512. The packet structure of DMX512 is shown in FIG. 11. The protocol allows the transmission of 8 bits (one byte) of information for up to 512 addresses at 250,000 bits/second (bps). The packets also contain header information at the beginning of the packet and trailing check sum information. In a traditional implementation of DMX512, each light source may require several bytes of information for controlling the color wheel location, pan, tilt, dimmer or other relevant control information.

The 512 addresses available in each packet are fixed. For example, a typical lighting system may be composed of several light sources A, B, C, etc. The first address of the 512 available may be defined to be the 8 bit binary control for the dimmer of light source A. Once this assignment is made, the first address location must continue to be used for the dimmer control of light source A for each and every future packet transmitted. Likewise, the second address, once assigned, must for example be the pan control of light source A for each and every packet. The address locations are physically wired with cabling and additions beyond 512 addresses require the cost and labor of more cables.

The above mentioned communication protocol was intended for theatrical lighting systems with a finite number of lights each with a color wheel, a dimmer, and possibly pan or tilt capabilities. Extensions of DMX512 currently exist and utilize DMX512 with 8 bit control of each color input—Red, Green, and Blue. To transmit a custom color definition, the color is broken into its constituents—a Red component, a Green component, and a Blue component. Each component is defined on a scale of 0 to 255 with 0 indicating no contribution of that color and 255 indicating a maximum (100%) contribution of the color. After transmission the receiving hardware sums the Red, Green, and Blue components to render a custom color for the user.

One of the difficulties with an RGB implementation of DMX512 protocol is the definition of a standard RGB color space. With the utilization of a RGB color coordinate system there is a huge potential for miscommunication with lighting consoles from different manufacturers transmitting color specifications to fixtures from other manufacturers. To produce accurate color rendering the sending and receiving hardware must both be communicating with the same RGB standard. With so many RGB standards in existence this may be a formidable task.

The use of an RGB implementation over DMX512 is not ideal for communication with LED light sources because it requires three bytes of information, as a minimum, for each LED light source. One byte control is also needed for each of RGB. Each light source therefore consumes at least 3 bytes of the available 512 addresses, inferring that an RGB implementation of DMX512 protocol allows for communication with a maximum of 170 LED light sources (512/3=170).

A further feature of the present invention is a communication protocol capable of transmitting exact color specifications and control information for LED light engine assemblies. The color specifications are capable of specifying any visible color and are not limited to colors that are a sum of Red, Green, and Blue components. The color specifications are repeatable and device independent. The color specification data can be communicated dynamically in real time across existing computer or telecommunications networks. To implement such a system, the LED light engine assemblies each contain a unique address and control hardware and software to render the specified color.

Computer or telecommunications networks do not generally transmit light control information to LED light engines assemblies. Some early attempts to do such have been marginally successful, but their primary downfall, as recognized by the present inventor, has been defining the color using a color specification of a summation of Red, Green, and Blue components. As discussed above, RGB color specifications are not standardized, repeatable, or device independent. Additionally, RBG color specifications do not address all visible colors. A secondary downfall of early attempts, as recognized by the present inventor, has been the transfer of a limited DMX512 lighting protocol to the computer network rather than adapting a current computer network protocol to LED light engine assemblies.

In a further feature the present invention develops a protocol for communicating precise color specifications to LED light engine assemblies. Each assembly contains a unique address or name so that it can discern specifications intended for its own use versus specifications intended for other LED light engine assemblies in the lighting system. All colors that are visible to the human eye can be specified using the color specifications. This is in contrast to current systems that only use the sum of Red, Green, and Blue color and that contain only 256 options for a Red component, 256 options for a Green component, and similarly 256 options for a Blue component. The light specifications are conveyed in the data portion of existing computer and telecommunications networks and are transmitted dynamically in real time to the LED light engine assemblies.

Specific details of a first implementation are now discussed. The present invention is not intended to be limited to this implementation, but the details of the first implementation add to further understanding of the present invention.

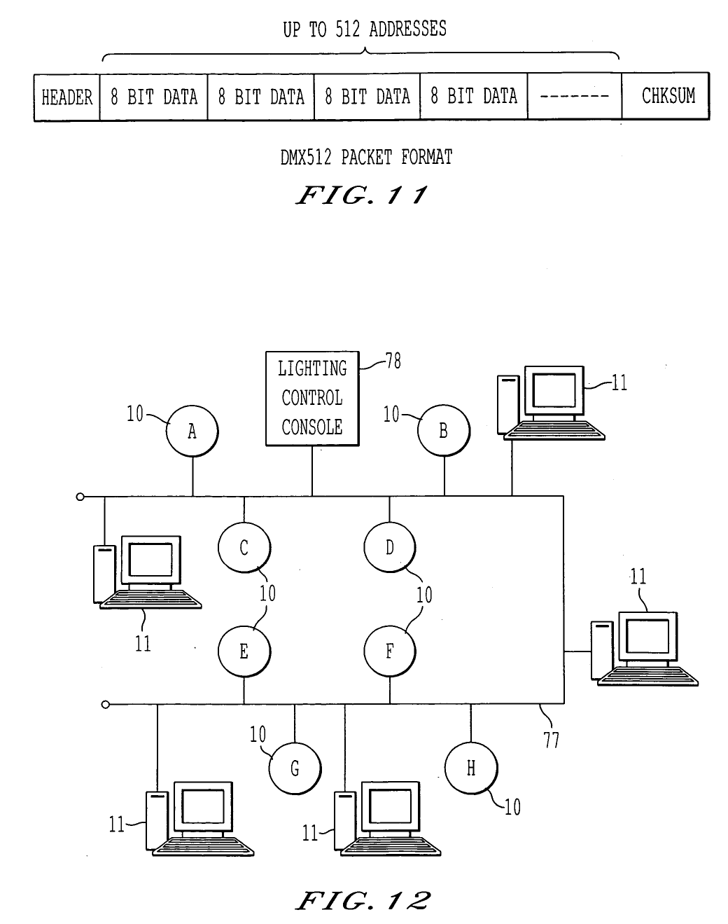

A first implementation utilizes an Ethernet based communication protocol traveling at 10 Million bps or Fast Ethernet traveling at 100 Mbps-40 or 400 times the speed of DMX512. This implementation travels on Ethernet networks as portrayed in FIG. 12. A number of LED light engine assemblies 10 labeled A-H are connected to an existing topology or network 77, to which any number of computers or workstations 11 can also be connected. A lighting control console 78 is also attached to the network 77. The lighting control console 78 can be similar to the consoles of DMX512, a dedicated computer for lighting control, or an existing computer with LED light-specific control hardware and software. The topology or network 77 can be a Bus Topology as shown in FIG. 12, a Hub and Spoke (Star) Topology, a Wireless System, or other acceptable network topology. The increased data communication rate of Ethernet can provide an advantage in such an implementation of the present invention.

The addition and interconnection of LED light engine assemblies 10 to any network topology similar to network 77 is also beneficial because of the prevailing use of computers, the internet, cell phone networks, and wired and wireless connectivity in today's society. The protocol of this first implementation is Ethernet based and is intended to operate on Ethernet connectivity systems. Hence, a lighting system using the architecture of the present invention can be easily added to any facility (i.e. office building, conference center, nightclub, theater, home, etc) with an existing Ethernet infrastructure.

Color specifications in this implementation in the present invention are preferably transmitted using the (x, y, Y′) coordinates of the CIE Color Coordinate System, thereby using a universal color coordinate system, rather than any of the aforementioned RGB standards. Integer or floating point representation of the lighting specification data can be used. Integer representation using 16 bits can be chosen. Floating point requires at least 32 bits and is more costly and less efficient than integer arithmetic. Values can be converted to integers by scaling appropriately at the source and destination.

There are other universal color coordinate systems that are device independent and that could also be utilized to describe the light output. The Lab Model uses Lightness, an “a” coordinate along a green to red spectrum and a “b” coordinate along a blue to yellow spectrum. The Munsell Color System uses three coordinates of Hue, Value, and Chroma. Any of the aforementioned RGB standards or CMYK standards (Cyan, Magenta, Yellow or Black) could also convey the target light output, but the lack of universality and device dependency of both RGB and CMYK systems compromises the quality of the light output. The present invention is not limited to the usage of a specific color coordinate system, although the CIE System may be the most effective.

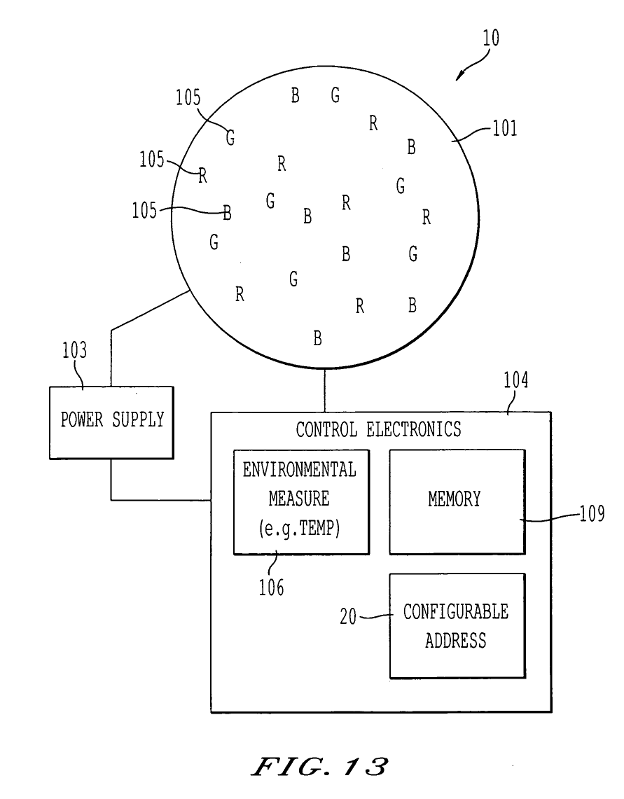

LED light engine assemblies of the current state of the art do not contain an internal address. To implement any communication scheme, each LED light engine assembly must contain an electronic address that is configurable for each assembly. Such an implementation is shown in FIG. 13 in which an electronic address 20 is added for this embodiment of the present invention. In this way, each assembly 10 on the network 77 will have a unique address. The address 20 is how the lighting control console 78 refers to individual of the LED light engines 10 when communicating directives.

FIG. 13 shows the LED assembly 10 including the configurable address 20. In addition, as shown in the dashed lines in FIG. 13 the LED assembly can also include the memory 109 such as in the embodiment of FIG. 7. That is, the LED assembly 10 does not necessarily require the memory 109 storing the premeasured data as noted above, but such a memory 109 can be added to achieve all the benefits of the embodiment discussed above with respect to FIGS. 1-8 in the present specification.

With DMX512 there is a maximum of 512 addresses and the address locations can not be interchanged from one packet to the next. Communicating with additional address locations using DMX512 requires the addition of extra cabling. The present invention can preferably use an Ethernet-like specification to broadcast color specifications to the LED light engine assemblies 10.

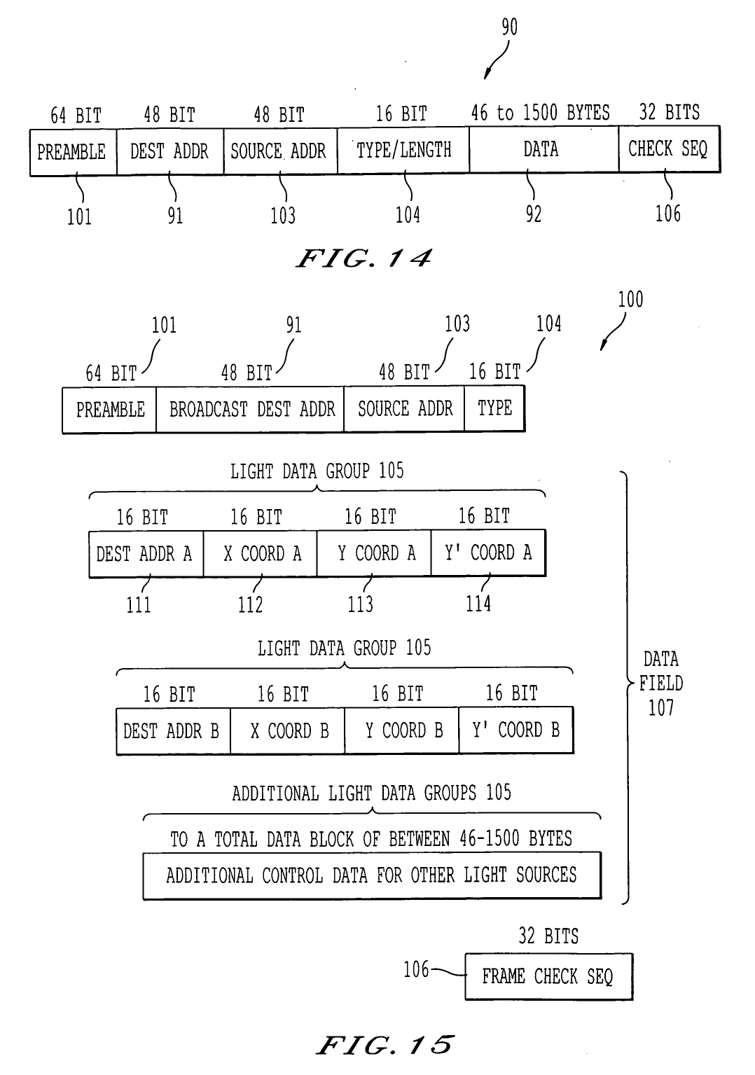

FIG. 14 details the structure of an Ethernet Frame communicated over the network topology of FIG. 12 or some similar network topology. There are several different versions of Ethernet, including Ethernet 802.3, Ethernet II, Ethernet 802.2, and Ethernet SNAP, but the frame contents are similar. The 64 bit Preamble field 101 signifies the beginning of a frame and synchronizes the frame with the network. The 48 bit Destination Address field 91 identifies the recipient of the data frame. The 48 bit Source Address field 103 identifies the sender of the data frame. Some of the Ethernet versions use the 16 bit field 104 for specifying the Type and some use it for specifying the Length field. Type fields describe the device specific data to follow. Length fields quantify the size of the data. The Data field 92 contains the information to be transmitted from the source to the destination and can be in the range of 46 to 1500 bytes. The 32 bit Frame Check Sequence 106 verifies the data and allows the recipient to check for the possibility of corruption in the transmission.

One implementation for light generation would be to use the Ethernet frame as described above—each frame containing a Preamble, a Destination Address, a Source Address, Type or Length control, Data, and a Frame Check Sequence. The minimum amount of data in each packet is 46 bytes of information. Each LED light engine assembly 10 is a destination, containing a configurable destination address 20. The light output of each LED assembly 10 is controlled by a lighting control console 78 transmitting color specifications. However, the transmitted data for a stationary light source will typically be only 6 bytes-2 bytes (16 bits) each for the (x, y, Y′) CIE coordinates. The additional bytes up to a total of 46 bytes must be padded with zeroes. In this case, there would be 6 bytes of information and 40 bytes of padded zeroes; the inefficiency of which is obvious.

A modification that can be implemented in this invention modifies the Ethernet Frame for use with a large number of destinations and a small amount of data to be sent to each destination. The various segments of the modified frame of the present invention are as detailed below:
(1) Preamble: as defined in the Ethernet Specifications;
(2) Destination Address: a binary series indicating a broadcast message that should be read by all of the light engines;
(3) Source Address: the binary location of the source generating the frame;
(4) Type or Length: as defined in the Ethernet Specifications;
(5) Data: 46 to 1500 bytes of information being sent to a number of different destinations; The data shall include the destination address as well as the control information for the destination, detailed further below; and
(6) Frame Check Sequence: as defined in the Ethernet Specifications.

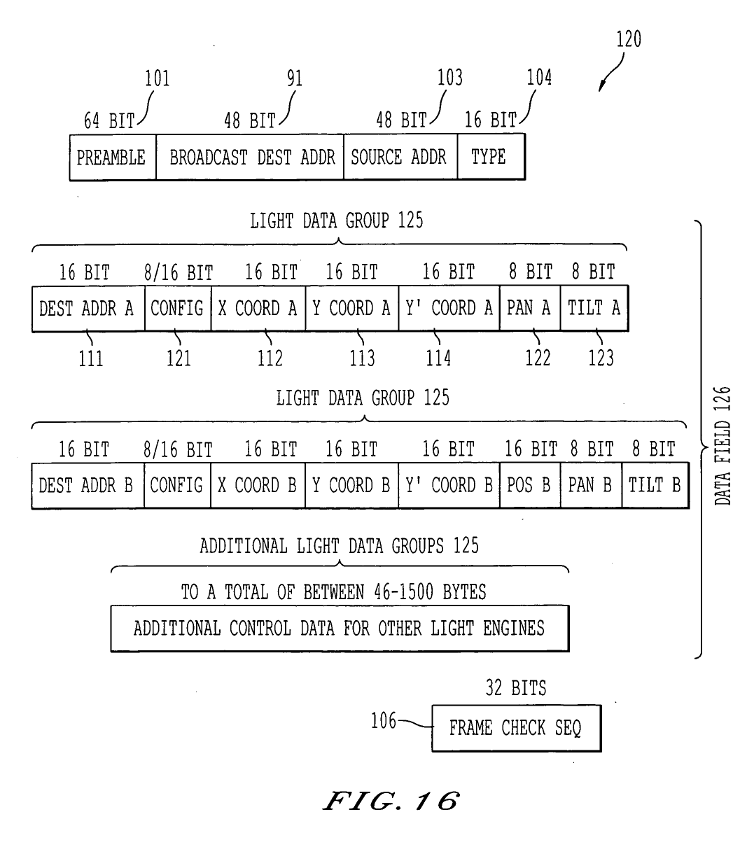

An example of the communication frame for such an implementation in the present invention can be as follows. First, assume there is an architectural lighting system in a large office building composed of light sources A, B, C, etc., and that all of the light sources are stationary—that is they are not capable of traversing along a rail, panning, or tilting. In that usage a system utilizing a single packet of information 100 as depicted in FIG. 15 can be implemented. The destination address 111 for the light control information is embedded into the body of the data block 105. The field intended to contain the destination address 111 further contains binary data indicating that it is broadcasting lighting specifications. The indicator of a broadcast packet would signal the light sources to read and evaluate the entire transmitted frame because the data field contains lighting control information. The data field 92 of the Ethernet-like protocol for stationary light fixtures contains data in Light Data Groups 105, including:

Destination Address field 111 of the light source to display the specified color;

CIE x coordinate field 112 of the light specification;

CIE y coordinate field 113 of the light specification;

CIE Y′ coordinate field 114 of the light specification.

The data field 92 contains such information for each destination on the network 77, as shown in FIG. 15.

If each frame can contain 1500 bytes of data and 8 bytes are required to address each light source, then each frame can specify as many as 187 light sources (1500 divided by 8) with accurate, device-independent, and universal color specifications. The next frame can accurately control the same 187 destinations, an entirely new set of 187 destinations or some combination thereof. Therefore, the protocol of the present invention allows a larger number of destination addresses to each receive small amounts of data. This resolves one deficiency of the direct Ethernet connection. By addressing different destinations with each successive frame, the protocol system of the present invention can address an unlimited number of locations. DMX512's inability to address more than 170 locations with a limited (65,536 variations) color specifications is also resolved.

The protocol can be further generalized for moving light sources, that is light sources with the capability of traversing, panning, or tilting. FIG. 16 shows an example frame for moving light sources. The frame is similar to the frame of FIG. 15, and hence many of the features are named and numbered identically. FIG. 16 adds a Configuration field 121, Pan field 122, and Tilt field 123. The Configuration field 121 is a binary number that defines the format of the information in the data field, the Pan field 122 indicates a pan of light source, and the Tilt field 123 indicates a tilt of the light source. Systems of stationary lights are relatively easily to control because only the color of light needs to be specified. Moving systems are more complex because in addition to control of target color specifications with (x, y, Y′), some light engines may also require control of pan. In others, only tilt control is added to the target color specification. Or in some instances, pan, tilt and position may need to be controlled but the target color specification may not be required. The Configuration field 121, therefore, communicates the format of the information in the data field of the frame. The Configuration field 121, Pan field 122, and Tilt field 123 could be located within the data block 105 as shown in FIG. 15, or incorporated into the Type/Length field 104 or elsewhere in the frame.

It is unlikely that within the network 77 all light specifications will arrive at the LED light engine assembly 10 as CIE coordinates (x, y, Y′). For this reason, in the present invention a conversion algorithm as shown below can be utilized in any light source 10 on the network. The conversion algorithm can transform a target RGB specification in the format (Rₜ, Gₜ, Bₜ) into CIE coordinates (xₜ, yₜ, Yₜ′). The process involves making some assumptions about the CIE coordinates of the standard Red 51, standard Green 52, and standard Blue 53 of the targeted output. The fact that the assumptions of these values must occur is an inherent weakness specifying color as RGB.

The conversion algorithm calculates a theoretical white point for the center of the RGB color space and then uses this white point to calculate scale factors (Sᵣ, S_{g}, S_{b}) for the conversion matrix. The conversion matrix [M] is used to perform the conversion from (Rₜ, Gₜ, Bₜ) of the target color to Tristimulus values (Xₜ, Yₜ, Zₜ) for the target color. The algorithm 130 concludes by using the defining equations 136 to translate the Tristimulus values (Xₜ, Yₜ, Zₜ) to CIE coordinates of the target color (xₜ, yₜ, Yₜ). Further details of the entire algorithm are as follows.

The conversion algorithm commences with a targeted color definition specified in an RGB specification system
Given (Rₜ, Gₜ, Bₜ) (131)

The CIE Chromaticity coordinates (x, y, Y′) for the Red, Green and Blue of the RGB color specification are also required for the algorithm. If the RGB color specification system is unknown, the CIE values may have to be assumed.
Given or Assumed (xᵣ, yᵣ, Yᵣ′), (x_{g}, y_{g}, Y_{g}′), (x_{b}, y_{b}, Y_{b}′) (132)
z need not be given for any of the colors because of the defining equation.
x+y+z=1 (133)
z=1−x−y

Linear proportionality constants (weighting factors) for the relationship between the Output Intensity and y coordinate for the RGB standard Red, Green and Blue are calculated.
mᵣ=(Yᵣ′/yᵣ)
m_{g}=(Y_{g}′/y_{g}) (134)
m_{b}=(Y_{b}′/y_{b})

The proportionality constants are used to calculate the CIE coordinates of the combination of RGB standards Red, Green, and Blue—ideally a true white color.

$${x}_{w} = \frac{{x}_{r} {m}_{r} + {x}_{g} {m}_{g} + {x}_{b} {m}_{b}}{{m}_{r} + {m}_{g} + {m}_{b}} \\ {y}_{w} = \frac{{y}_{r} {m}_{r} + {y}_{g} {m}_{g} + {y}_{b} {m}_{b}}{{m}_{r} + {m}_{g} + {m}_{b}} \\ {Y}_{w}^{′} = {Y}_{r}^{′} + {Y}_{g}^{′} + {Y}_{b}^{′} \qquad ( 135 )$$

CIE coordinates are converted to Tristimulus values, which is simply a different coordinate system for describing the color. The relationship between the 2 coordinate systems is defined by the following equations.
Y=Y′ x=X/(X+Y+Z) y=Y/(X+Y+Z) z=Z/(X+Y+Z) (136)

The following general equations can be quickly derived from equations 31 and 34 above.

$$\frac{x}{y} = \frac{X}{Y} \\ \frac{z}{y} = \frac{Z}{Y} \\ \frac{Z}{Y} = \frac{( 1 - x - y )}{y} \qquad ( 137 )$$

These general equations can then be utilized to create the equations for the Tristimulus values X, Y, Z for the RGB color specifications standard Red, Green and Blue and the resultant white.

$${X}_{r} = \frac{{x}_{r} {Y}_{r}^{′}}{{y}_{r}} {Y}_{r} = {Y}_{r}^{′} {Z}_{r} = \frac{( 1 - {x}_{r} - {y}_{r} ) {Y}_{r}^{′}}{{y}_{r}} \\ {X}_{g} = \frac{{x}_{g} {Y}_{g}^{′}}{{y}_{g}} {Y}_{g} = {Y}_{g}^{′} {Z}_{g} = \frac{( 1 - {x}_{g} - {y}_{g} ) {Y}_{g}^{′}}{{y}_{g}} \\ {X}_{b} = \frac{{x}_{b} {Y}_{b}^{′} }{{y}_{b}} {Y}_{b} = {Y}_{b}^{′} {Z}_{b} = \frac{( 1 - {x}_{b} - {y}_{b} ) {Y}_{b}^{′}}{{y}_{b}} \\ {X}_{w} = \frac{{x}_{w} {Y}_{w}^{′}}{{y}_{w}} {Y}_{w} = {Y}_{w}^{′} {Z}_{w} = \frac{( 1 - {x}_{w} - {y}_{w} ) {Y}_{w}^{′}}{{y}_{w}} \qquad ( 138 )$$

Scale Factors (Sᵣ, S_{g}, S_{b}) are calculated using the known Tristimulus values for the Red, Green and Blue standards and the calculated white from the following equation.

$$[ \begin{matrix}{S}_{r} & {S}_{g} & {S}_{b}\end{matrix} ] = {[ \begin{matrix}{X}_{w} & {Y}_{w} & {Z}_{w}\end{matrix} ] [ \begin{matrix}{X}_{r} & {Y}_{r} & {Z}_{r} \\ {X}_{g} & {Y}_{g} & {Z}_{g} \\ {X}_{b} & {Y}_{b} & {Z}_{b}\end{matrix} ]}^{- 1} \qquad ( 139 )$$

This results in the transformation matrix below.

$$[ M ] = [ \begin{matrix}{S}_{r} {X}_{r} & {S}_{r} {Y}_{r} & {S}_{r} {Z}_{r} \\ {S}_{g} {X}_{g} & {S}_{g} {Y}_{g} & {S}_{g} {Z}_{g} \\ {S}_{b} {X}_{b} & {S}_{b} {Y}_{b} & {S}_{b} {Z}_{b}\end{matrix} ] \qquad ( 140 )$$

The Tristimulus Values for the target color specification are (Xₜ, Yₜ, Zₜ)
[Xₜ Yₜ Zₜ]=[Rₜ Gₜ Bₜ] [M] (141)

The Tristimulus values of (Xₜ, Yₜ, Zₜ) can then be converted to CIE Coordinates by the defining equations (136).

$${x}_{t} = \frac{{X}_{t}}{{X}_{t} + {Y}_{t} + {Z}_{t}} \\ {y}_{t} = \frac{{Y}_{t}}{{X}_{t} + {Y}_{t} + {Z}_{t}} \\ {Y}_{t}^{′} = {Y}_{t} \qquad ( 142 )$$

Completion of the algorithm allows the usage of CIE coordinates (xₜ, yₜ, Yₜ′) when [Rₜ Gₜ Bₜ] was specified.

In summary, this further feature in the present invention has a number of advantages over DMX512 and variations of DMX512. Color specifications are defined with a large number of variations. The clarity of the CIE Color Specification standard versus the ambiguity of RGB Color Standards is employed. The clarity of the CIE specification is because it is independent on the rendering device, is repeatable, and is capable of specifying all colors. A transformation algorithm from RGB to CIE is an important feature of the communication protocol in the event that color specifications are received in RGB format. An almost infinite number of destinations can be addressed with the herein described protocol versus an RGB implementation of DMX512 addressing only 170 with each physical cable. The present invention can use a high speed computer and telecommunications networks in the Million bps speed range or higher versus the 250 Kbps of DMX512. Lastly, the physical hardware of existing networks makes the system cost effective for retrofits and new installations.

Obviously, numerous additional modifications and variations of the present invention are possible in light of the above teachings. It is therefore to be understood that within the scope of the appended claims, the present invention may be practiced otherwise than as specifically described herein.

1. A system comprising:
(a) a network;
(b) a plurality of light emitting diode (LED) assemblies connected to the network, and each including a unique address; and
(c) a control unit connected to the network and configured to send light control signals to the LED assemblies individually, the light control signals including color information in a universal color coordinate system.

2. The system according to claim 1, wherein the universal color coordinate system is CIE color coordinate system.

3. The system according to claim 1, wherein the network utilizes an Ethernet based communication protocol.

4. The system according to claim 2, wherein the network utilizes an Ethernet based communication protocol.

5. The system according to claim 3, wherein the light control signals are provided in Ethernet frames including in a data field a destination address indicating one of the LED assemblies and the CIE color coordinate information.

6. The system according to claim 5, wherein the Ethernet frame further includes in the data field at least one configuration information, pan information, and tilt information for the indicated one of the LED assemblies.

7. The system according to claim 4, wherein the light control signals are provided in Ethernet frames including in a data field a destination address indicating one of the LED assemblies and the CIE color coordinate information.

8. The system according to claim 7, wherein the Ethernet frame further includes in the data field at least one configuration information, pan information, and tilt information for the indicated one of the LED assemblies.

9. A system comprising:
(a) a network;
(b) a plurality of light emitting diode (LED) assemblies connected to the network, and each including a unique address; and
(c) means connected to the network for sending light control signals to the LED assemblies individually, the light control signals including color information in a universal color coordinate system.

10. The system according to claim 9, wherein the universal color coordinate system is CIE color coordinate system.

11. The system according to claim 9, wherein the network utilizes an Ethernet based communication protocol.

12. The system according to claim 10, wherein the network utilizes an Ethernet based communication protocol.

13. The system according to claim 11, wherein the light control signals are provided in Ethernet frames including in a data field a destination address indicating one of the LED assemblies and the CIE color coordinate information.

14. The system according to claim 13, wherein the Ethernet frame further includes in the data field at least one configuration information, pan information, and tilt information for the indicated one of the LED assemblies.

15. The system according to claim 12, wherein the light control signals are provided in Ethernet frames including in a data field a destination address indicating one of the LED assemblies and the CIE color coordinate information.

16. The system according to claim 15, wherein the Ethernet frame further includes in the data field at least one configuration information, pan information, and tilt information for the indicated one of the LED assemblies.
